(19) United States
(12) Patent Application Publication
(10) Pub. No.: US 2012/0087603 A1
(43) Pub. Date: Apr. 12, 2012

(54) SEALING MECHANISM AND PACKING DEVICE WITH THE SAME

(75) Inventors: YUN-LUNG CHEN, Tu-Cheng (TW); CHUNG CHAI, Tu-Cheng (TW); CHUAN-KAI CHANG, Tu-Cheng (TW)

(73) Assignee: HON HAI PRECISION INDUSTRY CO., LTD., Tu-Cheng (TW)

(21) Appl. No.: 13/151,463

(22) Filed: Jun. 2, 2011

(30) Foreign Application Priority Data
Oct. 8, 2010 (CN) 201010500016.0

(51) Int. Cl. B65D 33/16; B67B 7/00

(52) U.S. Cl. 383/69; 53/329

(57) ABSTRACT

A sealing mechanism includes a holding member and a securing member. A positioning hole is defined in the holding member and two flanges extend from the holding member and cooperatively defining a gap for receiving a packing bag. The securing member is received in the holding member and includes a positioning post. The securing member deforms the two flanges between a first position and a second position. In the first position, the two flanges extend outside in opposite direction so that an acute angle defined between the two flanges, and the positioning post is disengaged from the positioning hole. In the second position, the two flanges are substantially parallel to each other, the positioning post is engaged in the positioning hole, and the securing member is engaged with the packing bag.

### BACKGROUND

1. Technical Field

The present disclosure relates to a sealing mechanism and a packing device with the sealing mechanism.

2. Description of Related Art

Packing bags often include a plastic bag adapted for receiving electronic components. First, a plurality of electronic components are enclosed inside the plastic bag. Second, a knot is formed on the plastic bag for sealing the bag, to protect the electronic components from being contaminated with moisture. However, air usually leaks into the bag from a gap surrounding the knot, which will allow moisture to get at the electronic components.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a packing device in accordance with an embodiment.

FIG. 2 is an assembled view of FIG. 1.

FIG. 3 is a partially cross section view of FIG. 2 along line III-III.

FIG. 4 is similar to FIG. 2, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

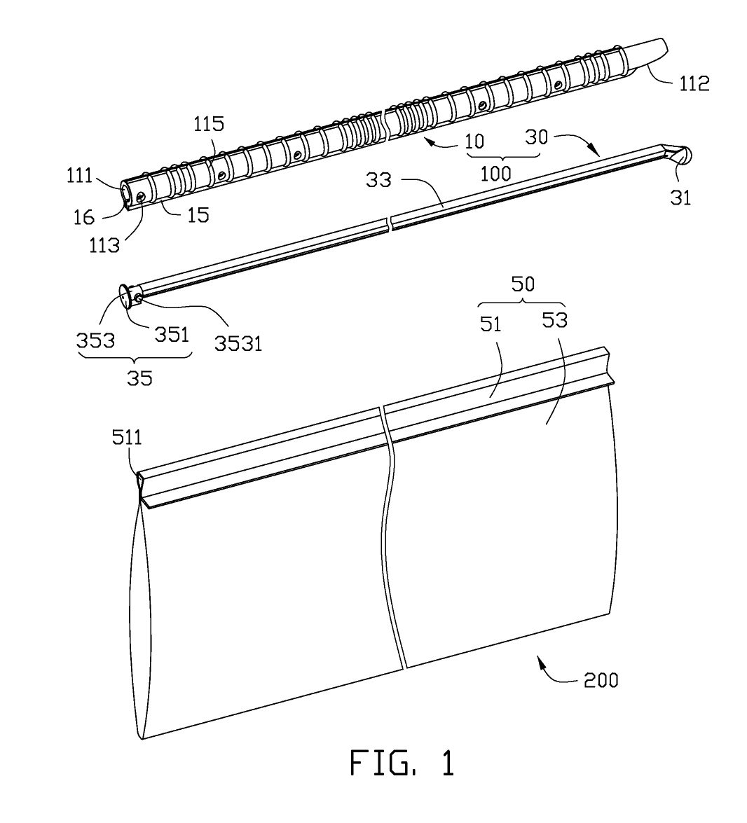

Referring to FIG. 1, a packing device in accordance with an embodiment includes a sealing mechanism 100 and a packing bag 200 engaged with the sealing mechanism 100. In one embodiment, the packing bag 200 is made of a sealable material, such as latex.

The sealing mechanism 100 includes a holding member 10 and a securing member 30. A through hole 111, sized for receiving the securing member 30, is defined in the holding member 10. A pair of positioning holes 113 is defined in the holding member 10. Two flanges 15 are located on the holding member 10, and a gap 16 is defined between the two flanges 15. In one embodiment, the two flanges 15 are parallel with each other. The gap 16 communicates with the through hole 111. In one embodiment, an end of the holding member 10 defines an entrance 112. A plurality of washers 115, offering friction for the holding member 10, is located on an outer surface of the holding member 10. The holding member 10 is elastically deformable between a first position, where a first width of the gap 16 is less than diameter of the through hole 111, and a second position, where a second width of the gap 16 in the second position is greater than the first width of the gap 16.

The securing member 30 includes a main body 33, a pushing portion 31 located on a first end of the main body 33, and a securing portion 35 located on a second end of the main body 33. In one embodiment, the pushing portion 31 is at an obtuse angle to the main body 33, and a cross section of the main body 33 is a triangle.

The securing portion 35 includes a head 351 and a neck 353 connected to the head 351. Two positioning posts 3531, arranged in a row, protrude from an outer surface of the neck 353. The two positioning posts 3531 can be engaged in the corresponding positioning holes 113. In one embodiment, a diameter of the head 351 is greater than that of the through hole 111.

The packing bag 200, with an opening (not shown), includes a body 50. The body 50 includes a first portion 51 and a second portion 53 connected to the first portion 51. The first portion 51 defines a receiving hole 511.

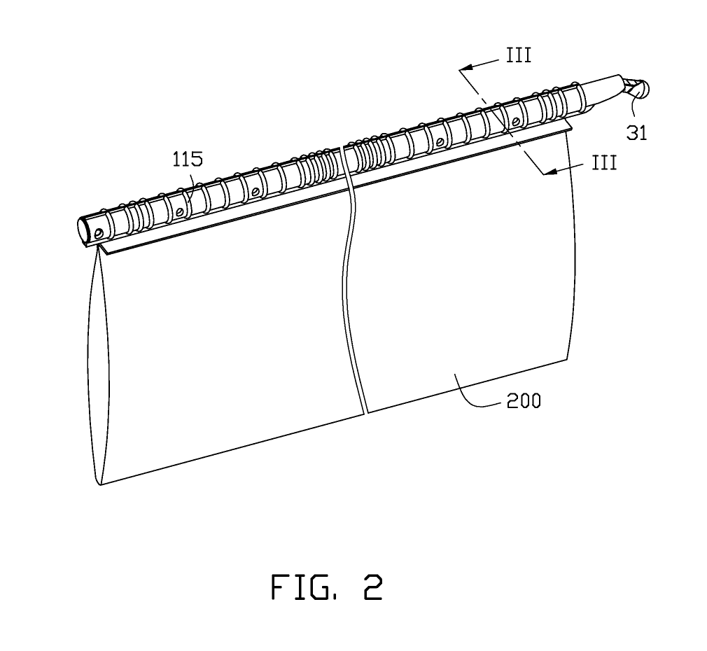

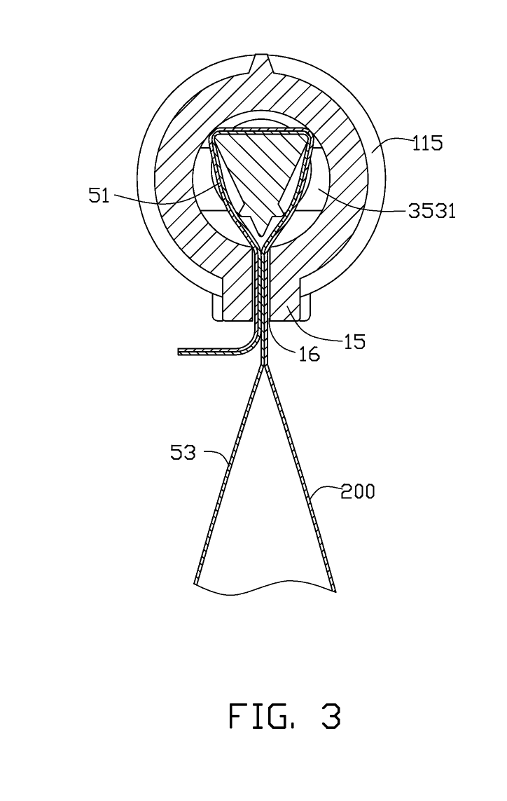

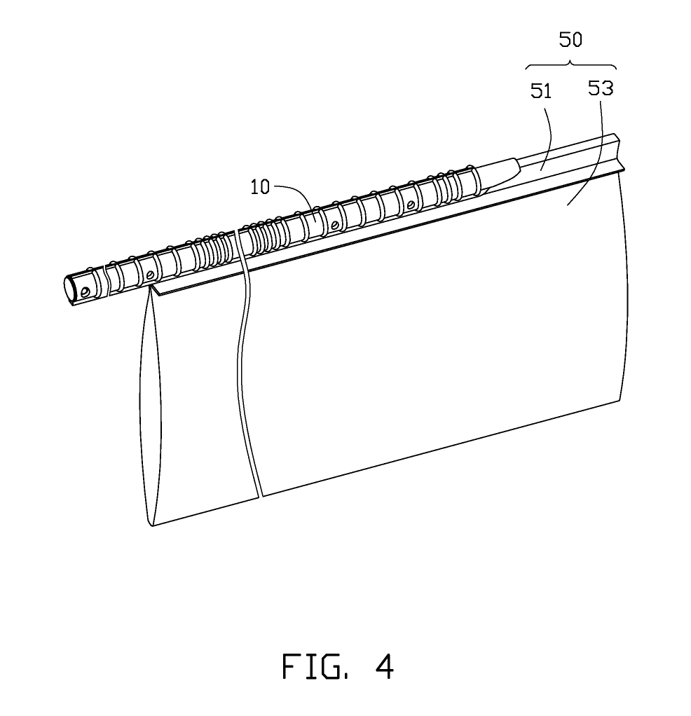

Referring to FIGS. 2-4, in assembly, the head 351 of the securing member 30 is aligned with the entrance 112 of the holding member 10, and the pushing portion 31 is located under the entrance 112. The pushing portion 31 is operated, to move the securing member 30 in a first direction into the through hole 111. The head 351 thus deforms the holding member 10, until the head 351 is passed through the through hole 111 and is located outside the through hole 111. The two positioning posts 3531 are aligned with the pairs of positioning holes 113, and the pushing portion 31 is aligned with the entrance 112. The holding member 10 is resiliently released, and the two positioning posts 3531 are engaged with corresponding positioning holes 113.

A first end of the first portion 51 is aligned with the pushing portion 31, and the pushing portion 31 is received in the receiving hole 511. The packing bag 200 is pulled in the first direction, and a part of the packing bag 200, adjacent to the first portion 51, is received in the gap 16. The packing bag 200 is further pulled, to deform the two flanges 15 outside and increase the width of the gap 16, so an acute angle is defined between the two flanges 15. When a second end of the packing bag 200 is received in the gap 16, the two flanges 15 are resiliently released, to tighten the packing bag 200.

In disassembly, the packing bag 200 is pulled in a second direction opposite to the first direction, to deform the two flanges 15. Therefore, the packing bag 200 is disengaged from the sealing mechanism 100.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A sealing mechanism comprising:
a holding member with a positioning hole; two flanges extending from the holding member, and a gap, adapted for a packing bag passed through, between the two flanges; and
a securing member, received in the holding member, comprising a positioning post;
wherein the securing member is adapted to deform the two flanges between a first position, where the two flanges extend outside in opposite direction so that an acute angle defined between the two flanges, and the positioning post is disengaged from the positioning hole; and a second position, where the two flanges are substantially parallel to each other, and the positioning post is engaged in the positioning hole, so that the securing member is engaged with the packing bag.

2. The sealing mechanism of claim 1, wherein a through hole, communicating with the gap, is defined in the holding member, and the securing member is received in the through hole.

3. The sealing mechanism of claim 2, wherein a securing portion, is located on the securing member, and the positioning post is located on an outer surface of the securing portion.

4. The sealing mechanism of claim 3, wherein the securing member comprises a main body and a pushing portion, the main body is located between the securing portion and the pushing portion, and the pushing portion is adjacent to an entrance of the through hole.

5. The sealing mechanism of claim 4, wherein the pushing portion extends at an obtuse angle to the main body.

6. The sealing mechanism of claim 4, wherein the securing portion comprises a head and a neck connected to the head, and a diameter of the neck is less than that of the head.

7. The sealing mechanism of claim 6, wherein a diameter of the head is greater than that of the through hole.

8. The sealing mechanism of claim 1, further comprising a plurality of washers, and the plurality of washers is located on an outer surface of the holding member.

9. A packing device comprising:
a holding member with a positioning hole; two flanges extending from the holding member, and a gap, adapted for a packing bag passed through, defined between the two flanges;
a securing member, received in the holding member, comprising a positioning post; and
a packing bag, the packing bag engaged in the gap;
wherein the securing member is adapted to deform the two flanges between a first position, where the two flanges extend outside in opposite direction so that an acute angle defined between the two flanges, and the positioning post is disengaged from the positioning hole; and a second position, where the two flanges are substantially parallel to each other, and the positioning post is engaged in the positioning hole, so that the securing member is engaged with the packing bag.

10. The packing device of claim 9, wherein the packing bag comprises a first portion and a second portion, a receiving hole is defined in the first portion, and the securing member is engaged in the receiving hole.

11. The packing device of claim 10, wherein a through hole, communicating with the gap, is defined in the holding member, and the securing member is received in the through hole.

12. The packing device of claim 11, wherein a securing portion is located on the securing member, and the positioning post is located on an outer surface of the securing portion.

13. The packing device of claim 12, wherein the securing member comprises a main body and a pushing portion, the main body is located between the securing portion and the pushing portion, and the pushing portion is adjacent to an entrance of the through hole.

14. The packing device of claim 13, wherein the pushing portion extends at an obtuse angle to the main body.

15. The packing device of claim 13, wherein the securing portion comprises a head and a neck connected to the head, and a diameter of the neck is less than that of the head.

16. The packing device of claim 15, wherein a diameter of the head is greater than that of the through hole.

17. The packing device of claim 9, further comprising a plurality of washers, and the plurality of washers is located on an outer surface of the holding member.
